(19) United States
(12) Patent Application Publication
(10) Pub. No.: US 2014/0378201 A1
(43) Pub. Date: Dec. 25, 2014

(54) SYSTEM FOR LOTTERY GAMES

(71) Applicants: Volodymyr Kolomiiets, Cherkassy (UA); Oleksandr Krasiuk, Cherkassy (UA); Denys Kolomiyets, Cherkassy (UA)

(72) Inventors: Volodymyr Kolomiiets, Cherkassy (UA); Oleksandr Krasiuk, Cherkassy (UA); Denys Kolomiyets, Cherkassy (UA)

(21) Appl. No.: 13/925,702

(22) Filed: Jun. 24, 2013

(51) Int. Cl. G07F 17/32

(52) U.S. Cl. CPC G07F 17/329
USPC 463/17

(57) ABSTRACT

A lottery game system with an increased unpredictability of the winning combination due to expansion of game possibilities by introduction of a principle of competitiveness not only according to the quantity of coincidence of combinations of elements chosen by players (graphic and/or numerical designations) with combinations that have been determined by a random value or otherwise at random, but also at a level of interest in productivity of one competitive system over another, as the ultimate amount of the prize depends on which system of bets becomes effective (i.e. wins).

### CROSS-REFERENCE TO RELATED APPLICATIONS

This patent application claims priority to, and incorporates fully by reference, Ukraine Patent Application No. 2012/12823, filed Nov. 12, 2012.

### FIELD OF THE INVENTION

This invention relates to systems for executing lottery games based on fixed odds and draw-based lotteries.

### BACKGROUND OF THE INVENTION

Various known methods for lottery exist. One such device, designed for television game show lottery (“SMS Lotto”), contains a block of random number winning combinations in the form of several spinning reels. The number of reels is equal to the number of characters involved in the draw, with each reel installed in a series and labeled with numbers (Description for Invention RU No. 2006124348, published Jan. 20, 2008).

Another known method creates winning combinations of game elements by random/accidental removal of game elements. Each game element is in the form of a disk and is located within a portable container with slits on the surface which are used for placing or removing game elements (patent RU 2378031 Marencev O.V.).

Other methods for lottery include formation of a winning combination with game elements in the form of balls or barrels, which are located within and withdrawn from a special bag or bucket (Wingame “Russian lotto” 164A/001/RLO, License No. 13 of Mar. 10, 1996).

It is also known that most winning lottery combinations are determined by simple coincidence, i.e., combinations that have been determined at random by players.

### SUMMARY OF THE INVENTION

A system for lottery games comprising: a Data Reception Unit, a Unit for generation of random variables and/or arrangement for accidental extraction or loss of game elements, a Memory Unit, a Performance Unit, and at least 2 competing systems of bets. The claimed system conducts a drawing through which the winning combination of game elements is determined by successive accidental removal or loss of game elements and/or with the use of random variable generation; the winning result is determined by comparing the drawn combination with the data received from participants (bets on graphic and/or numeric designations) in order to determine matching and mismatching bets. The system for lottery games, in a single edition, includes two competitive systems of bets on graphic and/or numeric designations. Each system consists of a number of groups of graphic and/or numeric designations, and has two-way communication with the Unit for generation of random variables and/or arrangement for accidental extraction or loss of game elements. The Unit for generation of random variables and/or arrangement for accidental extraction or loss of game elements carries out separate drawings, thus determining independent actions/graphics of a virtual event. This generated information is then communicated to the Memory Unit, for determination of the first winner of the game, and simultaneously to the Performance Unit, for determination of the second winner of the game.

### BRIEF DESCRIPTION OF THE DRAWINGS

FIG. 1 shows how the different elements of the claimed system interact.

### DETAILED DESCRIPTION OF THE PREFERRED EMBODIMENT

A system for conducting lottery games, relating to systems of games for cash/money and other forms of betting, which can be used in conducting lotteries, using known methods for determining winning combinations at random with the help of random variables, lotto, and other means.

The claimed system refers to a lottery system in which players (a.k.a. participants, ticketholders) bet on the actions/graphics/numerals and results associated with a virtual event. The event could be, for example, any sporting match, a political event, an artistic performance, etc. Participants will place bets on any number of paper or electronic tickets, and the claimed system will calculate the prize distribution through comparison of the participants' entries with those of the generated virtual event.

A common feature of the prior art, which is used today in the application of lottery systems, is to determine the winner by random number generation, or the sequential loss or retrieval of game elements. This common attribute is also used as a feature of the presently claimed system prototype for lottery games.

The technical result of this lottery game system is to increase the unpredictability of the winning result by a sequence of independent draws in two separate competitive systems, followed by comparison of the results of the independent competitive systems to determine the final result and winner. Another result of this system is to increase the interest of game participants due to expansion of game possibilities by introduction of a principle of competitiveness not only according to the quantity of coincidence of combinations of elements chosen by players (graphic and/or numerical designations) with combinations that have been determined by random draw or otherwise at random (i.e. draw-based lottery), but also at a level of interest in the productivity/success of one competitive system of bets, chosen by the player, over another competitive system, as the amount of the ultimate prize depends and on what system of bets becomes effective (i.e. which system wins the competition—a fixed odds lottery). Essentially, the present invention combines two forms of lottery—draw-based and fixed odds into one system or game.

The declared system comprises: a Data Reception Unit 100, a Unit for generation of random variables and/or arrangement for accidental extraction or loss of game elements (a.k.a. random number generator, or “RNG”) 200, two separate Units representing two systems of bets (graphical and/or numerical designations), which compete against each other Competitive system 1 301 and Competitive system 2 302, a Memory Unit 400, and a Performance Unit 500. Together, these individual units combine to operate in two directions simultaneously. Once the RNG 200 generates a set of numbers/graphics, the Memory Unit 400 generates the first criteria for the overall winning combination, while at the same time, the Performance Unit 500 generates the second criteria for determining the overall winner. The two criteria are then combined according to the rules of the game in order to determine the final prize distribution.

Together, the Data Reception unit, the Memory unit, at least two competing systems, and the Performance unit combine to form what can be referred to as the “hardware-software complex” of the claimed system. Also, theoretically, more than two competing systems can form the hardware-software complex; the number of competing systems will depend on the rules of the game and how many virtual event members can exist.

Each competitive system 301, 302 consists of bets of groups of graphics and/or numeric symbols from 1 to N, which are determined by game rules. The number of graphic and/or numeric symbols in each group is determined by the rules of each game. For each group of graphic and/or numeric designations in each competitive system of bets, separate drawings are carried out, either consecutively or otherwise. In each drawing, independent winning results are determined by the RNG 200. These results are recorded in the Memory Unit 400, where a winner is determined by comparison of the data of players' bets (on graphic and/or numerical designations in their selected system of bets) with the appropriate (i.e. actual) independent winning results, provided by the Data reception Unit 100, which has two-way communication with the RNG 200. Via this process, a winner is determined based on the number of correct bets made regarding the actions/graphics of the game (i.e. a table of results for each competitive system is constructed). This determination can be referred to as the first stage of the reward system, or the first criteria for determining the overall winner.

At the same time as the first set of winners are determined by the Memory Unit 400, further processing occurs in the Performance Unit 500. The competitiveness of Competitive system 1 301 and Competitive system 2 302 consists in the fact that the Performance Unit 500 compares each independent winning result of Competitive system 1 with each corresponding independent winning result of Competitive system 2, according to the conditions created by the rules of the game. The Performance Unit 500 determines which competitive system has greater or lesser effectiveness/productivity—those players who choose the correct competitive system will win this portion of the lottery game. This step can be referred to as the second stage of the reward system, and the second criteria for determining the overall winner.

The ultimate prize is distributed according to game rules, providing a prize for both the player(s) who chose the winning system as well as the player(s) who most correctly chose the actions/graphics of the game. The amount that each group of winners is rewarded depends on the size of the overall prize, the rules of the game, or by a factor or fixed amount of the total prize.

These steps are sufficient to achieve the technical result previously stated.

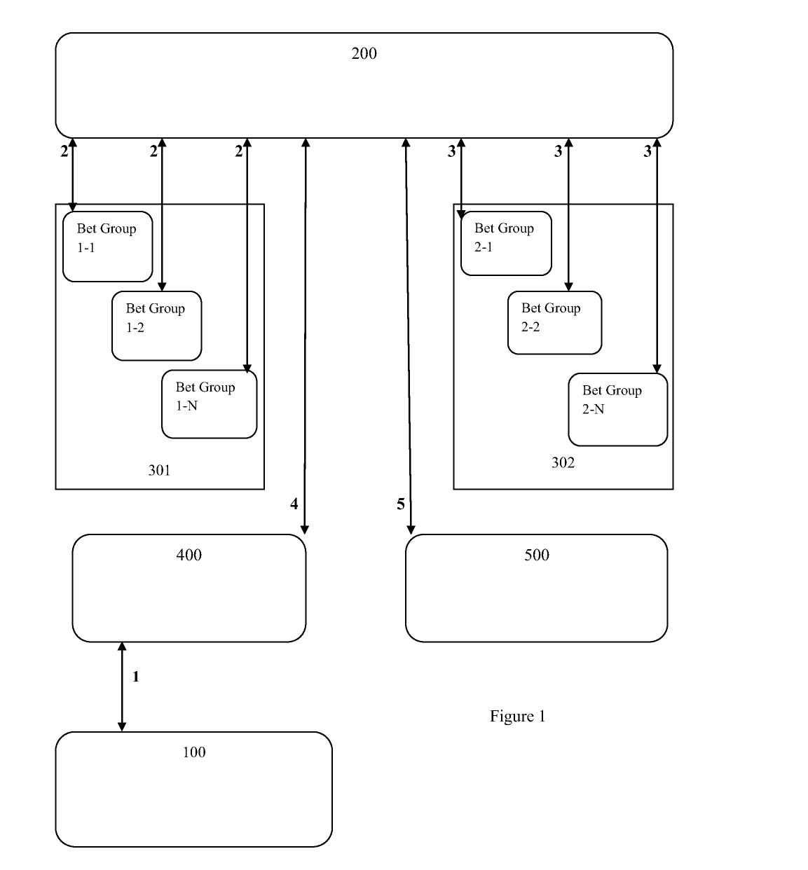

In the Drawings, FIG. 1 shows how the different elements of the system interact: (1) the Data Reception Unit 100 has two-way communication with the Memory Unit 400, sending to it the processed data (i.e. the bets) on the graphic and/or numeric designations made by participants in their chosen system of bets (Competitive system 1 301 or Competitive System 2 302); (2) the Unit for generation of random variables and/or arrangement for accidental extraction or loss of game elements (“RNG) 200 has two-way communication with each group of graphic and/or numeric designations within Competitive system 1 301, allowing for a lottery in each individual group, determined by independent draws for winning results (draw 1-1, draw 1-2, . . . draw 1-N); (3) the Unit for generation of random variables and/or arrangement for accidental extraction or loss of game elements has two-way communication with each group of graphic and/or numeric designations within Competitive system 2302, allowing for a lottery in each individual group, determined by independent draws for winning results (draw 2-1, draw 2-2, . . . draw 2-N); (4) after each draw, the RNG 200 routes the winning result (the result of each individual draw—1-1, 1-2, . . . 1-N, and 2-1, 2-2, . . . 2-N) to the Memory Unit 400, which compares such winning result with the corresponding bets, made by the participants and received from the Data reception Unit 100, and determines matching and mismatching bets; (5) the RNG 200 has two-way communication with the Performance Unit 500, which receives all winning results and determines the performance by comparing the winning result draws for Competitive system 1 with the winning result draws for Competitive system 2.

The following example illustrates one embodiment of the stated lottery game system: Lottery tickets, in hard copy and electronic form, are distributed among the players (i.e. participants). This lottery edition contains two competitive betting systems. In this particular game, a virtual boxing match is held between Boxer A and Boxer Z (Competitive system A and Competitive system Z, respectively). Competitive system A regards the actions of Boxer A. Competitive system Z corresponds to the actions of Boxer Z. A player/participant may choose either or both competitive systems (one system per ticket, but as many tickets as desired), and within each system, the player must successfully select actions for the boxer, such as punches and/or defenses. These proposed actions are combined into appropriate groups, in accordance with the rules of the game, thus creating the player's bets. In the case of a boxing match game, each ticket provides for the choice of one out of three attack moves (i.e. punches), and one out of three defensive moves (i.e. blocks) per round (6 total rounds). Thus, by analogy to a numerical lottery, a ticketholder must choose 12 numbers out of a block of 36 numbers, and only one number (1-3) from each row. These selected bets, in the form of data, are routed, by known means, to the hardware and software of the Data reception Unit. Then, they are sent to the Memory Unit together with information about the selected competitive system (e.g. Competitive system A, Competitive system Z). Independent draws are then made by the RNG for each group of bets, and the independent winnings results are determined by comparing the randomly generated actions of the Boxers with the actual bets made by each ticketholder. This is the first criteria for determining the winner. The resulting draws made by the RNG are simultaneously recorded and sent to the Performance Unit for a second round of processing. The Performance Unit compares each independent winning result of each group of bets of Competitive system A with the appropriate independent winning result of each group of bets of Competitive system Z, thus determining the competitive system with greater effectiveness/productivity (i.e. the winner of the boxing match), in accordance with the conditions defined by the rules of the game. This is the second criteria for determining the winner of the lottery game. The overall winner is decided by the number of correctly guessed actions/defenses as well as whether or not the given ticketholder chose the winning competitive system. For example, a player who guessed the most actions/defenses and also chose the winning system might win 70% of the available prize, while a player who guessed the most actions/defenses but chose the losing system might only win 30% of the same prize.

Technical solutions that match the set of essential features of this invention have not been found, which permits concluding that the “novelty” condition for patentability has been met.

The use of this system is possible and beneficial during the lottery with accidental deletion or loss of game elements, and/or using random variable generation, indicating that the condition is of “industrial application”.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A system for lottery games comprising: at least two competing units, each representing a system which competes with the other, a Data Reception Unit for collection of participant/ticketholder data, a Unit for random number generation and/or arrangement for accidental extraction or loss of game elements (“RNG”), a Memory Unit which compares the Data Reception Unit data with RNG-generated data, and a Performance Unit which determines said competing systems' productivity/effectiveness, wherein the first winning criteria and winner are determined by said Memory Unit, and wherein the second winning criteria and winner are determined by said Performance Unit.

2. The system of claim 1, wherein all Units have two-way communication with all other Units.

3. The system of claim 1, wherein each competing system represents an individual, a team, or any group or number of competitors.

4. A system for lottery games, based on the outcome of a virtual event, comprising: a plurality of paper or electronic tickets, at least two competing systems within a hardware-software complex, and a random number generation unit, wherein said hardware-software complex determines prize distribution based on an overall result and simultaneously based on the actions/graphics/numerals which lead to said result.

5. The system of claim 4, wherein said hardware-software complex further comprises: a Data Reception Unit, a Memory Unit for comparison of ticket data with random number generation unit data, and a Performance Unit for determination of the winning competing system based on results of said random number generation unit.

6. The system of claim 5, wherein each Unit has two-way communication with every other unit.

7. A system for lottery games, based on a virtual event, comprising: at least two competing units, each representing a system which competes with the other, a Data Reception Unit, a Memory Unit, and a Performance Unit, wherein players' bets on the winning competing unit and on the actions/graphics which lead to the winning result are calculated simultaneously, thus combining a draw-based lottery and a fixed-odds lottery into one game.
